(19) United States
(12) Patent Application Publication
(10) Pub. No.: US 2022/0417146 A1
(43) Pub. Date: Dec. 29, 2022

(54) METHOD AND APPARATUS FOR DETERMINING ROUTE FOR OCH SERVICE, AND STORAGE MEDIUM

(71) Applicant: ZTE CORPORATION, Shenzhen, Guangdong (CN)

(72) Inventor: Huan HE, Shenzhen, Guangdong (CN)

(21) Appl. No.: 17/780,018

(22) PCT Filed: Oct. 29, 2020
(86) PCT No.: PCT/CN2020/124939

§ 371 Date: May 25, 2022

(30) Foreign Application Priority Data
Nov. 25, 2019 (CN) 201911166425.9

(51) Int. Cl. H04L 45/00; H04Q 11/00

(52) U.S. Cl. CPC H04L 45/62; H04Q 11/0062

(57) ABSTRACT

The present disclosure provides a method and apparatus for determining a route for an OCH service, and a storage medium. The OCH service route determination method includes: determining a spectral width required for an OCH service in an optical network; and successively determining at least one path in a route for the OCH service from a start network element of the OCH service to an end network element of the OCH service. A maximum available spectral width of each of the at least one path in the route is greater than or equal to the spectral width required for the OCH service.

### CROSS REFERENCE TO RELATED APPLICATIONS

The present disclosure claims priority to Chinese patent application No. 201911166425.9, filed Nov. 25, 2019, which is incorporated by reference herein in its entirety.

### TECHNIC FIELD

The various embodiments described in this document relate in general to optical communication network technology, and more specifically to a method and apparatus for determining a route for an optical channel (OCH) service, and a storage medium.

### BACKGROUND

With the rapid development of communication technology, more and more data need to be transmitted through communication network. Optical transport network, which uses optical fiber as a main transmission medium, has the characteristics of high transmission speed and long transmission distance.

Wavelength-division multiplexing (WDM) networks have become the preferred network in the optical network, however, channel resources of the WDM networks become more and more insufficient with rapid development of information technology. In order to make full (or more flexible) use of WDM channel resources, flexible grid technology is introduced to devices. The flexible grid technology is wavelength-variable technology (or spectral width-variable technology). For each wave, a required spectral width is selected according to a capacity of information to be carried by the wave. If the wave needs to carry an enormous capacity (e.g., 500 G), a relatively large spectral width is used to carry more information. If the wave only needs to transmit a small capacity, a relatively small spectral width is used to save wavelength resources.

However, after the application of the flexible grid technology, the variable spectral width affects determination of routes of optical channel (OCH) services. Therefore, how to calculate the routes of the services accurately in the application of the flexible grid technology is an urgent problem to be solved.

### SUMMARY

Embodiments of the present disclosure provide a method and apparatus for determining a route for an OCH service, and a storage medium, which are able to accurately calculate routes of OCH services in an optical network using flexible grid technology.

Some embodiments of the present disclosure provide a method for determining a route for an OCH service, including: determining a spectral width required for the OCH service in an optical network; and successively determining at least one path in the route for the OCH service from a start network element of the OCH service to an end network element of the OCH service, wherein a maximum available spectral width of each of the at least one path in the route is greater than or equal to the spectral width required for the OCH service.

Some embodiments of the present disclosure further provide an apparatus for determining a route for an OCH service, including: a spectral width determining module, configured to a spectral width required for the OCH service in an optical network; and a route determining module, configured to successively determine at least one path in the route for the OCH service from a start network element of the OCH service to an end network element of the OCH service, wherein a maximum available spectral width of each of the at least one path in the route is greater than or equal to the spectral width required for the OCH service.

Some embodiments of the present disclosure further provide an optical network controller, including: at least one processor; and memory communicatively coupled to the at least one processor; wherein the at least one processor is configured to execute program instructions stored in the memory to perform the method for determining a route for an OCH service in the above embodiments.

Some embodiments of the present disclosure further provide a storage medium storing computer programs that, when executed by at least one processor, cause the at least one processor to perform the method for determining a route for an OCH service in the above embodiments.

### BRIEF DESCRIPTION OF THE DRAWINGS

FIG. 1 is a schematic diagram of spectral width in an optical network.

FIG. 2 is a schematic diagram of route determination in an optical network in which flexible grid technology is not used.

FIG. 3 is a flowchart of a method for determining a route for an OCH service according to some embodiments of the present disclosure.

FIG. 4 is a schematic diagram of maximum available spectral width between network elements in an optical network in which flexible grid technology is used.

FIG. 5 is another schematic diagram of maximum available spectral width between network elements in an optical network in which flexible grid technology is used.

FIG. 6 is a flowchart of another method for determining a route for an OCH service according to some embodiments of the present disclosure.

FIG. 7 schematic diagram of route determination in a method for determining a route for an OCH service according to some embodiments of the present disclosure.

FIG. 8 is a schematic structural diagram of an apparatus for determining a route for an OCH service according to some embodiments of the present disclosure.

FIG. 9 is a schematic structural diagram of an optical network controller according to some embodiments of the present disclosure.

### DETAILED DESCRIPTION OF THE EMBODIMENTS

Embodiments of the present disclosure will be described below in detail with reference to the accompanying drawings.

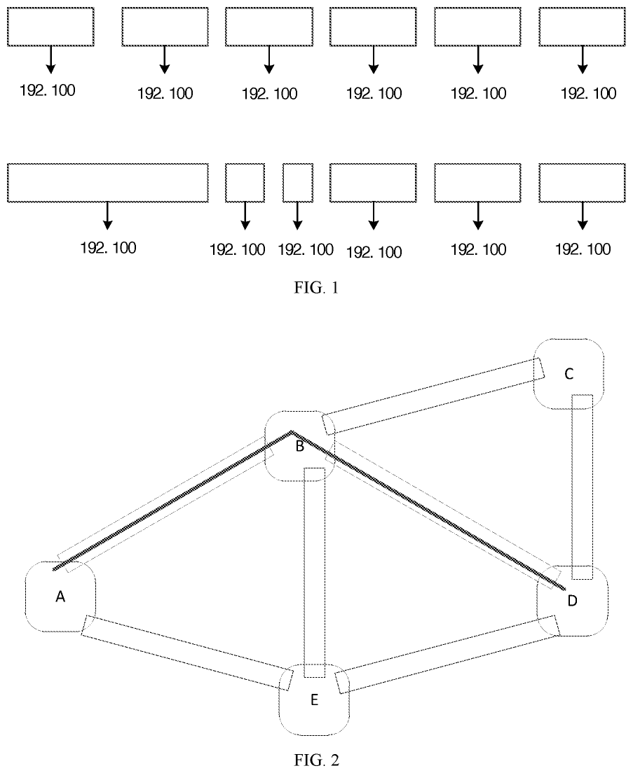

In optical communication networks, flexible grid technology provides variable spectral width, which is able to adjust spectrum widths of various wavelengths according to the amount of data to be transmitted. FIG. 1 is a schematic diagram of spectral width in an optical network. As shown in an upper half of FIG. 1, spectral widths of all wavelengths are equal on an optical fiber without using the flexible grid technology. As shown in a lower half of FIG. 1, the spectral widths of all the wavelengths are variable on the optical fiber after using the flexible grid technology. Each spectral width of the wavelengths is able to be adjusted according to the capacity of information to be transmitted. A lateral length of each block in FIG. 1 represents a spectral width of one wavelength, and 192.100 schematically represents an address of each wavelength.

In the optical network, a route needs to be determined for an OCH service when the OCH service is activated. Since available spectral widths of all the wavelengths are the same when the flexible grid technology is not used, the route is able to be determined according to the connection relationship of the service layer between respective network elements with a certain route calculation method. FIG. 2 is a schematic diagram of route determination in an optical network in which the flexible grid technology is not used. As shown in FIG. 2, the optical network includes five network elements A, B, C, D, E, each of which is connected with a plurality of other network elements through a plurality of channels of an optical service layer. When the OCH service needs to be activated, the route is calculated only through a preset route calculation method if a start network element of the OCH service is a network element A and an end network element is a network element D. For example, if a conventional route calculation method calculates a shortest route, the route from the network element A to the network element D through a network element B is obtained. The specific method for the route determination includes the following operations. Firstly, optical multiplex section (OMS) services at the service layer are abstracted as lines, i.e., connections of different wavelengths at the service layer between respective network elements in the network are used as available routing paths. Secondly, the OCH switching capabilities of the network elements are abstracted as lines, i.e., the OCH switching capabilities of the network elements are used as the available routing paths. Thirdly, the route is calculated through route calculation. After the route is determined, OCH cross-connections are created from the OCH switching capabilities in the device to activate the OCH service.

However, the spectral widths of different wavelengths between the network elements are variable after using the flexible grid technology, if the route is still determined according to the route determination method shown in FIG. 2, the spectral widths of the paths in the determined route may not be sufficient to transmit the data to be transmitted.

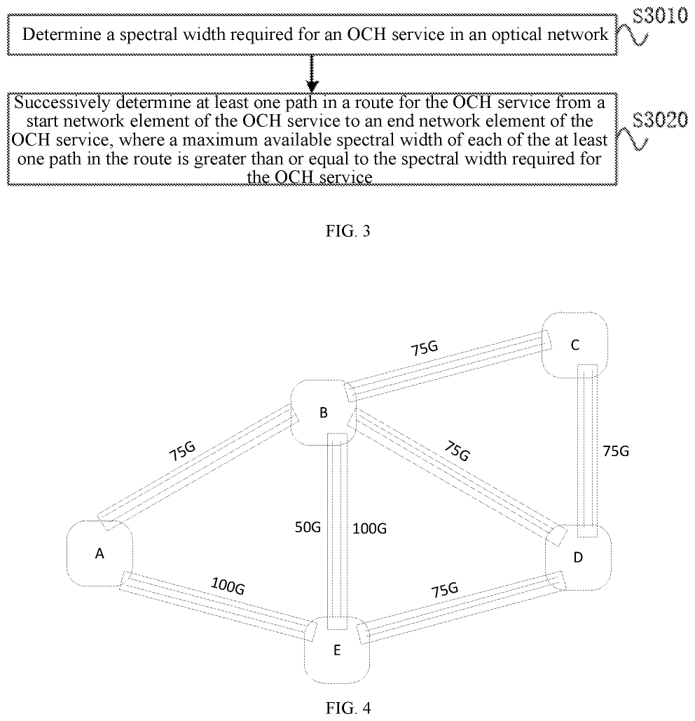

FIG. 3 is a flowchart of a method for determining a route for an OCH service according to some embodiments.

In S3010, determining a spectral width required for the OCH service in an optical network.

The method for determining a route for an OCH service provided in this embodiment is used to determine the route of the OCH service when the OCH service is activated in the optical communication network. In the optical network using the flexible grid technology, since the spectral widths of different wavelengths of optical links connected between the network elements are variable, the spectral width required for the OCH service in the optical network needs to be determined first in order to enable the determined route to meet a transmission requirement of the OCH service. The spectral width in the optical network is proportional to a capacity of the data able to be transmitted. The larger the spectral width, the larger the capacity of the data able to be carried. The spectral width required for the OCH service is a minimum spectral width required for the OCH service to perform data transmission, i.e., the minimum spectral width capable of meeting the requirement of the OCH service for the data transmission.

In S3020, at least one path in the route for the OCH service from a start network element of the OCH service to an end network element of the OCH service is successively determined. A maximum available spectral width of each of the at least one path in the route is greater than or equal to the spectral width required for the OCH service.

After determining the spectral width required for the OCH service, the route of the OCH service is to be determined. The start network element and the end network element of the OCH service are determinate, and determining the route of the OCH service is determining at least one path of the OCH service from the start network element to the end network element. In order to enable the route determined for the OCH service to be able to carry the OCH service after using the flexible grid technology, each path in the route determined for the OCH service is required to be able to carry the OCH service, i.e., the maximum available spectral width of each path in the route is required to be greater than or equal to the spectral width required for the OCH service. The spectral width required for the OCH service is positively correlated with the amount of data to be transmitted for the OCH service, i.e., the larger the maximum available spectral width of each path, the larger the data stream able to be transmitted. Since the relationship between the maximum available spectral width of each path in the route and the spectral width required for the OCH service is taken into account in determining the route of the OCH service, each path in the determined route is able to carry the amount of data to be transmitted for the OCH service, so that the route of the OCH service is accurately determined in the optical network using the flexible grid technology.

The paths in the determined route includes paths between respective network elements in the optical network, the paths between respective network elements are OMS services at a service layer between respective network elements, and a maximum available spectral width of each of the OMS services at the service layer between respective network elements includes a maximum available spectral width of each of center frequencies at the service layer between respective network elements. In the optical network, a plurality of OMS services at the service layer are included between respective network elements, and each of different wavelengths corresponds to one OMS service at the service layer. The different wavelengths are distinguished according to the center frequencies, and a spectral width of each wavelength at a different center frequency at the service layer between respective network elements corresponds to the maximum available spectral width of each of the OMS services at the service layer between respective network elements. Since a plurality of different OMS services at the service layer are included between respective network elements when determining the route of the OCH service, an OMS service corresponding to a center frequency of which the maximum spectral width is greater than or equal to the spectral width required for the OCH service is selected as the path in the route according to the spectral width required for the OCH service.

As shown in FIG. 4, FIG. 4 is a schematic diagram of a maximum available spectral width between network elements in an optical network in which the flexible grid technology is used. As shown in FIG. 4, the optical network includes five network elements A, B, C, D, and E in total, and the connection relationship of each network element is shown in FIG. 4. For example, a connection between every two network elements includes two paths, i.e., two OMS services at the service layer are included between every two network elements. It is shown in FIG. 4 that maximum available spectral widths of both paths between the network element A and the network element B are 75G bits per second (bps) (the unit ‘bps’ is omitted later), maximum available spectral widths of both paths between the network element A and the network element E are 100G, maximum available spectral widths of both paths between the network element B and the network element E are 100G and 50G, respectively, maximum available spectral widths of both paths between the network element B and the network element D are 75G, maximum available spectral widths of both paths between the network element B and the network element C are 75G, maximum available spectral widths of both paths between the network element C and the network element D are 75G, and maximum available spectral widths of both paths between the network element E and the network element D are 75G. It is seen from FIG. 4 that the maximum available spectral widths of multiple paths between different network elements may be the same or may be different.

The paths in the route further includes paths inside at least one network element in the optical network, and each path inside each network element represents the OCH switching capability of each network element. Since the network elements in the optical network are connected through different optical fibers, one network element may establish physical connections with a plurality of other network elements through optical fibers at the same time, the OCH switching capability between different network elements needs to be considered when determining the route of the OCH service.

In addition, in the optical network, certain network elements are in an electrical relay mode, i.e., one of the certain network elements converts an optical signal transmitted by another network element through the optical fiber into an electrical signal through photoelectric conversion, converts the electrical signal into the optical signal again, and then transmits the converted optical signal to the still another network elements through the optical fiber connection with the network element, and this optical-electrical-optical conversion is the electrical relay mode. When the network elements in the optical network are in the electrical relay mode, a spectral width of an optical signal after the optical-electrical-optical conversion may change. For example, a spectral width of an optical signal transmitted from a first network element to a second network element is 100G, and after the second network element performs electrical relay conversion on the received optical signal to output to a third network element, the spectral width of the optical signal may become 50G or 200G. Therefore, when each network element in the optical network is in the electrical relay mode during determining the route of the OCH service, the maximum available spectral width of each of the paths between the respective network elements being in the electrical relay mode is greater than or equal to the spectral width required for the OCH service converted through the electrical relay mode of each network element, i.e., making the paths between the respective network elements being in the electrical relay mode still meet the requirements of the OCH service.

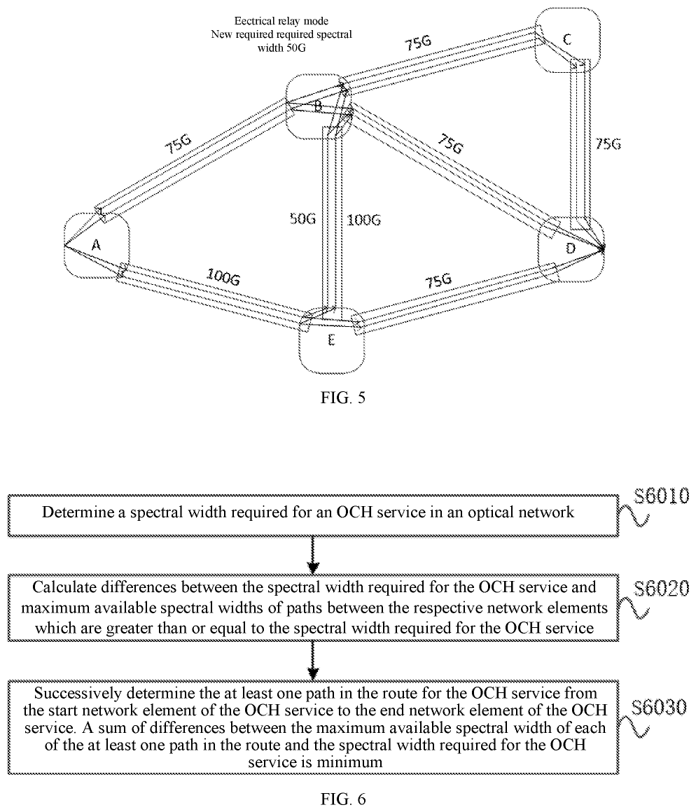

As shown in FIG. 5, FIG. 5 is another schematic diagram of a maximum available spectral width between network elements in an optical network in which the flexible grid technology is used. As shown in FIG. 5, the optical network includes five network elements A, B, C, D, and E in total, and the connection relationship of each network element is shown in FIG. 5. For example, a connection between every two network elements includes two paths, i.e., two OMS services at the service layer are included between every two network elements. Different switching paths are also provided inside each network element according to the OCH switching capability of each network element. For example, the network element B provides a switching path from the network element A to the network element C and a switching path from the network element A to the network element D, while the network element B does not provide a switching path from the network element A to the network element E. In addition, the network element B is in the electrical relay mode, and the spectral width required for the OCH service after being transmitted through the network element B becomes a spectral width of the network element B having been converted to the electrical relay mode. As an example, in FIG. 5, the spectral width of the network element B having been converted to the electrical relay mode is 50G. It is seen from FIG. 5 that a starting point of the OCH service is the network element A, and an ending point is the network element D. The network element A has switching capabilities to reach the network element B and reach the network element E. Maximum available spectral widths of both paths between the network element A and the network element B are 75G, maximum available spectral widths of both paths between the network element A and the network element E are 100G. The network element B has switching capabilities from the network element A to the network element C, from the network element A to the network element D, and from the network element E to the network element C. The network element B is in the electrical relay mode, the required spectral width after the electrical relay conversion is 50G, maximum available spectral widths of both paths between the network element B and the network element E are 100G and 50G respectively, maximum available spectral widths of both paths between the network element B and the network element D are 75G, and maximum available spectral widths of both paths between the network element B and the network element C are 75G. The network element C has switching capability from the network element B to the network element D, and maximum available spectral widths of both paths between the network element C and the network element D are 75G. The network element E has switching capabilities from the network element A to the network element B, and from the network element A to the network element D, and maximum available spectral widths of both paths between the network element E and the network element D are 75G.

The method for determining the route for the OCH service provided in this embodiment first determines the spectral width required for the OCH service in the optical network, and then successively determines at least one path in the route for the OCH service from the start network element of the OCH service to the end network element of the OCH service. The maximum available spectral width of each of the at least one path in the route is greater than or equal to the spectral width required for the OCH service. Since the relationship between the maximum available spectral width of each path in the route and the spectral width required for the OCH service is taken into account in determining the route of the OCH service, each path in the determined route is able to carry the amount of data to be transmitted for the OCH service, so that the route of the OCH service is accurately determined in the optical network using the flexible grid technology.

FIG. 6 is a flowchart of another method for determining a route for an OCH service according to some embodiments of the present disclosure. As shown in FIG. 6, the method for determining the route for the OCH service provided in the embodiments of the present disclosure includes the following operations.

In S6010, a spectral width required for an OCH service in an optical network is determined.

In S6020, differences between the spectral width required for the OCH service and maximum available spectral widths of paths between respective network elements that are greater than or equal to the spectral width required for the OCH service are calculated.

In the optical network, there may be a plurality of interconnected optical fiber links between network elements, and the same optical fiber links between two network elements may further include a plurality of OMS services of wavelengths at different center frequencies. In this case, there may be a plurality of routes, in which the maximum available spectral width of each path is greater than or equal to the spectral width required for the OCH service, from the start network element of the OCH service to the end network element of the OCH service, and thus one route of the OCH service needs to be determined among the plurality of possible routes. In fact, the plurality of routes, in which the maximum available spectral width of each path is greater than or equal to the spectral width required for the OCH service, from the start network element of the OCH service to the end network element of the OCH service are capable of carrying the amount of data to be transmitted by the OCH service, and any route selected as the route of the OCH service is able to ensure normal activation of the OCH service. However, when a maximum available spectral width of a path in the determined route is equal to the spectral width required for the OCH service, all available spectral widths of this path are utilized by the OCH service and no transmission resource is wasted. If a maximum available spectral width of a path in the determined route is larger than the spectral width required for the OCH service, a part of available spectral width of this route may never be used by the OCH service, and thus transmission resources are wasted.

Therefore, in the method for determining the route for the OCH service provided in this embodiment, differences between the spectral width required for the OCH service and maximum available spectral widths of paths between respective network elements that are greater than or equal to the spectral width required for the OCH service are first calculated when determining the route of the OCH service. That is to say, paths between respective network elements whose maximum available spectral width is greater than or equal to the spectral width required for the OCH service are first determined, and these paths are the paths capable of carrying the amount of data required for the OCH service. The differences between the spectral width required for the OCH service and the maximum available spectral widths between respective network elements are then calculated. The smaller the difference between the maximum available spectral width and the spectral width required for the OCH service, the less the spectral width occupied when the path carries the OCH service. Therefore, it is desirable to select the path with the smallest difference between the maximum available spectral width and the spectral width required for the OCH service when determining the route of the OCH service.

In S6030, the at least one path in the route for the OCH service from the start network element of the OCH service to the end network element of the OCH service is successively determined. A sum of differences between the maximum available spectral width of each of the at least one path in the route and the spectral width required for the OCH service is minimum.

In order to save the transmission resources in the optical network to the greatest extent, the sum of transmission resources occupied by all the paths in the entire route needs to be minimized when determining the route for the OCH service. After determining the differences between the spectral width required for the OCH service and the maximum available spectral widths of the paths between respective network elements that are greater than or equal to the spectral width required for the OCH service, the paths in the route for the OCH service from the start network element of the OCH service to the end network element of the OCH service are successively determined. The sum of the differences between the maximum available spectral widths of each path in the determined route and the spectral width required for the OCH service is minimum, i.e., the total transmission resources occupied by the route from the start network element of the OCH service to the end network element are minimized. In the route thus determined, the difference between the occupied transmission resources and the transmission resources required for transmitting the OCH service is minimum, and the use of the transmission resources is saved to the greatest extent on the basis of ensuring normal transmission of the OCH service.

In one embodiment, the route of the OCH service may be determined using the following route calculation algorithm. Firstly, the maximum available spectral width corresponding to the wavelength at each center frequency at the service layer of each network element in the optical network needs to be determined, i.e., the maximum available spectral width of the OMS service at the service layer of each network element in the optical network needs to be determined. Then, the OCH switching capability of each network element is determined, whether each network element is in the electrical relay mode is determined, and the maximum available spectral width of the network element having been converted to the electrical relay mode. Next, the spectral width required for the OCH service and the start and end network elements of the OCH service are determined, and the route from the start network element of the OCH service to the end network element is determined according to the following route calculation algorithm. Two endpoints of one OMS service at the service layer between respective network elements in the optical network are respectively used as nodes, i.e., endpoints of each path in the optical network are respectively used as nodes. The route calculation algorithm includes the following operations.

A. it is determined from the start network element of the OCH service whether the spectral width required for the OCH service of a current node of a current network element is greater than a maximum available spectral width of a center frequency where a neighboring node is at. In response to the spectral width required for the OCH service being greater than the maximum available spectral width, the neighboring node is discarded. That is, it is determined whether the spectral width required for the OCH service is greater than a maximum available spectral width of a path connecting the network elements. In response to the spectral width required for the OCH service being greater than the maximum available spectral width, the path is discarded, and maximum available spectral widths of remaining paths are greater than or equal to the spectral width required for the OCH service, thereby being capable of carrying the amount of data to be transmitted by the OCH service. B. a weight of each of the remaining paths is calculated. For example, the weight of each path is calculated using the following formula, i.e., (the maximum available spectral width of the path—the spectral width required for the OCH service)/the spectral width required for the OCH service. C. it is determined whether each node is in the electrical relay mode according to the switching capability of each network element. In response to the node being in the electrical relay mode, the required spectral width after the electrical relay conversion is used as the spectral width required for the OCH service after being transmitted through the node. D. paths of which the sum of weights is smallest in the route from the start network element of the OCH service to the end network element of the OCH service are successively determined. If a plurality of routes with the smallest sum of weights of the paths are determined, one of the plurality of routes may be selected as the determined route, or the route passing through the least number of nodes may be selected as the determined route, or the route may be determined according to another route determination algorithm.

The method for determining the route for the OCH service provided in this embodiment calculates the weights of the paths between respective network elements, considers the influence of the weights of the paths when determining the route of the OCH service, and uses the route with the smallest sum of the weights of the paths as the determined route, so that the determined route of the OCH service satisfies the amount of data to be transmitted by the OCH service, thereby reducing the occupation of the transmission resources in the optical network and improving the utilization rate of system resources.

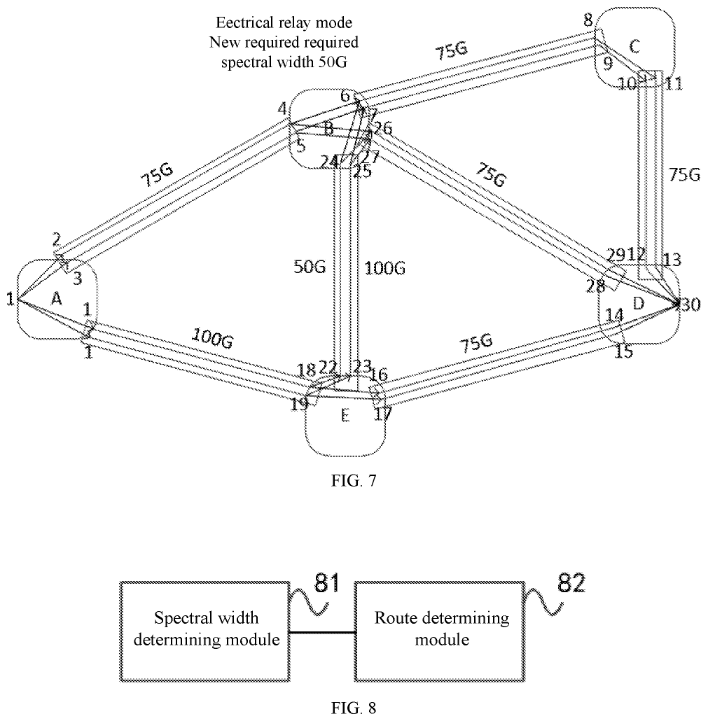

FIG. 7 is a schematic diagram of route determination in a method for determining a route for an OCH service according to some embodiments of the present disclosure. As shown in FIG. 7, the optical network includes five network elements A, B, C, D, and E in total, and the connection relationship of each network element is shown in FIG. 7. The paths between respective network elements and the switching capability of each network element in FIG. 7 are the same as those in FIG. 5. In determining the route of the OCH service from the network element A to the network element D, the maximum available spectral width of the OMS service at each center frequency at the service layer between respective network elements is first determined, as shown in FIG. 7. The OCH switching capability of each network element is then determined, whether each network element is in the electrical relay mode is determined, and a new required spectral width after the electrical relay conversion is determined. The start and end points of each OMS service are respectively taken as connection termination points (CTP) which are also referred to as nodes, and the number of each node is shown in FIG. 7.

Firstly, the spectral width required for the OCH service is determined, and then paths in the route for the OCH service from a node 1 of the network element A of the OCH service to a node 30 of the end network element D of the OCH service are successively determined. In this embodiment, the spectral width required for the OCH service is 100G as an example. A process of determining the route includes the following operations.

1. It is determined that the start network element is the network element A, the starting node is the node 1, the required spectral width is 100G, and the distance is zero. Herein, the distance is set for calculating the shortest route of the OCH service. Since the node 1 is the starting point of the OCH service, the distance starts from zero. The weight of the transmission distance between each the network element is set to 100, while the weight of the distance inside each network element for OCH service switching is set to 1.

2. Search for the neighboring nodes of the node 1. The neighboring nodes of the node 1 are nodes 2, 3, 20 and 21, respectively. The maximum available spectral widths of the center frequencies where the node 2 and node 3 are at are 75G, which are less than the spectral width 100G required for the OCH service, so the node 2 and node 3 are discarded. The maximum available spectral widths of the center frequencies where the node 20 and node 20 are at are 100G, which are equal to the spectral width 100G required for the OCH service. Therefore, it is determined that the spectral width required for the OCH service upon arrival at the node 20 is 100G and the distance is 1, and the spectral width required for the OCH service upon arrival at the node 21 is 100G and the distance is 1. The distance of 1 indicates a distance weight corresponding to the switching inside the network element.

3. Search for the neighboring nodes of the node 20 and node 21. The neighboring nodes of the node 20 and node 21 are nodes 18 and 19, respectively. It is determined that the spectral width required for the OCH service upon arrival at the node 18 is 100G and the distance is 101, and the spectral width required for the OCH service upon arrival at the node 19 is 100G and the distance is 101. The distance of 101 indicates a distance weight 100 for OCH service transmission between network elements plus a distance weight for OCH service switching inside the network element A.

4. Search for the neighboring nodes of the node 18 and node 19. The neighboring nodes of the node 18 are nodes 22 and 16, and the maximum available spectral width of the center frequency where the node 22 is at is 50G, which is less than the spectral width required for the OCH service. Therefore, the node 22 is discarded. The maximum available spectral width of the center frequency where the node 16 is at is 75G, which is less than the spectral width required for the OCH service. Therefore, the node 16 is discarded. The neighboring nodes of the node 19 are nodes 23 and 17, and the maximum available spectral width of the center frequency where the node 17 is at is 70G, which is less than the spectral width 100G required for the OCH service. Therefore, the node 17 is discarded. The maximum available spectral width of the center frequency where the node 23 is at is 100G, which is equal to the spectral width 100G required for the OCH service. Therefore, the node 23 is reserved. It is therefore determined that the spectral width required for the OCH service upon arrival at the node 23 is 100G, and the distance is 102.

5. Search for the neighboring node of the node 23. The neighboring node of the node 23 is the node 25. It is determined that the spectral width required for the OCH service upon arrival at the node 25 is 100G, and the distance is 202.

6. Search for the neighboring nodes of the node 25. The neighboring nodes of the node 25 are nodes 7 and 27. In addition, since the network element B in which the node 7 and the node 27 are located is in the electrical relay mode, the required spectral width after the electrical relay conversion is 50G. Therefore, the maximum available spectral width of the center frequency where the node 7 is at is 75G, which is greater than the spectral width 50G required for the OCH service converted through the electrical relay mode, and the maximum available spectral width of the center frequency where the node 27 is at is 75G, which is greater than the spectral width 50G required for the OCH service converted through the electrical relay mode. It is determined that the spectral width required for the OCH service upon arrival at the node 7 is 50G and the distance is 252, and it is determined that the spectral width required for the OCH service upon arrival at the node 27 is 50G and the distance is 252. Herein, the distance is 252, and a distance of 50 is increased on the basis of the operation ‘5’, indicating that the distance weight after the the electric relay conversion is 50.

7. Search for the neighboring node of the node 7. The neighboring node of the node 7 is the node 9, and it is determined that the spectral width required for the OCH service upon arrival at the node 9 is 50G, and the distance is 352. Search for the neighboring node of the node 27. The neighboring node of the node 27 is the node 28, and it is determined that the spectral width required for the OCH service upon arrival at the node 28 is 50G, and the distance is 352.

8. Search for the neighboring node of the node 9. The neighboring node of the node 9 is the node 10. The maximum available spectral width of the center frequency where the node 10 is at is 75G, which is greater than the spectral width 50G required for the OCH service. Therefore, the node 10 is reserved. It is therefore determined that the spectral width required for the OCH service upon arrival at the node 10 is 50G, and the distance is 353. Search for the neighboring node of the node 28. The neighboring node of the node 28 is the node 30, and the node 30 is an end point of the OCH service. Therefore, the distance of the path of the OCH service is determined to be 353.

9. Search for the neighboring node of the node 10. The neighboring node of the node 10 is the node 12, and it is determined that the spectral width required for the OCH service upon arrival at the node 12 is 50G, and the distance is 453. Search for the neighboring node of the node 12. The neighboring node of the node 12 is the node 30, and the node 30 is the end point of the OCH service. Therefore, the distance of the path of the OCH service is determined to be 454.

After the above calculation, two routes from the node 1 to the node 30 are determined, and a distance of one of the two routes is 353 and a distance of the other is 454, so the route with the shortest distance is determined, i.e., the route determined in operation ‘8’ is the route determined for the activated OCH service.

FIG. 8 is a schematic structural diagram of an apparatus for determining a route for an OCH service according to some embodiments of the present disclosure. As shown in FIG. 8, the apparatus for determining the route for the OCH service includes: a spectral width determining module 81, configured to a spectral width required for an OCH service in an optical network; and a route determining module 82, configured to successively determine at least one path in a route for the OCH service from a start network element of the OCH service to an end network element of the OCH service. A maximum available spectral width of each of the at least one path in the route is greater than or equal to the spectral width required for the OCH service.

The apparatus for determining the route for the OCH service provided in this embodiment is configured to implement the method for determining the route for the OCH service in the embodiment shown in FIG. 3. The implementation principle and technical effect of the apparatus for determining the route for the OCH service provided in this embodiment are similar to those in the embodiment shown in FIG. 3, which are not repeated in details herein.

In one embodiment, the route determining module 82 is further configured to, when each network element is in an electrical relay mode, the maximum available spectral width of each of the at least one path between the respective network elements being in the electrical relay mode is greater than or equal to the spectral width required for the OCH service converted through the electrical relay mode of each network element.

In one embodiment, the route determining module 82 is further configured to calculate differences between the spectral width required for the OCH service and maximum available spectral widths of paths between respective network elements that are greater than or equal to the spectral width required for the OCH service, to successively determine the at least one path in the route for the OCH service from the start network element of the OCH service to the end network element of the OCH service, wherein a sum of differences between the maximum available spectral width of each of the at least one path in the route and the spectral width required for the OCH service is minimum.

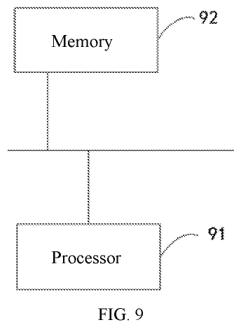

FIG. 9 is a schematic structural diagram of an optical network controller according to some embodiments of the present disclosure. As shown in FIG. 9, the optical network controller includes at least one processor 91 and memory 92 communicatively coupled to the at least one processor. The number of the at least one processor 91 in the optical network controller may be one or more, and one processor 91 is taken as an example in FIG. 9. The processor 91 and memory 92 in the optical network controller may be connected by a bus or other means, for example, the processor 91 and memory 92 in the optical network controller are connected by the bus in FIG. 9.

As a computer readable storage medium, the memory 92 may be configured to store software programs, computer-executable programs, and modules, such as program instructions/modules (e.g., spectral width determining module 81, route determining module 82 in apparatus for determining the route for the OCH service) corresponding to the method for determining the route for the OCH service in the embodiments of FIGS. 3-6 in the present disclosure. The processor 91 completes at least one functional application of the optical network controller and data processing, i.e., implements the above method for determining the route for the OCH service, by executing the software programs, instructions, and modules stored in the memory 92.

The memory 92 mainly includes a program storage area and a data storage area. The program storage area may store an operating system, an application program required for at least one function. The data storage area may store data or the like generated according to the use of the optical network controller. Furthermore, the memory 92 may include high-speed random access memory, and may further include non-volatile memory, such as at least one disk storage device, a flash memory device, or other non-volatile solid-state storage device.

Some embodiments of the present disclosure further provide a storage medium storing computer programs that, when executed by at least one processor, cause the at least one processor to perform a method for determining a route for an OCH service including: determining a spectral width required for an OCH service in an optical network, and successively determining at least one path in a route for the OCH service from a start network element of the OCH service to an end network element of the OCH service, where a maximum available spectral width of each of the at least one path in the route is greater than or equal to the spectral width required for the OCH service.

The above description merely includes exemplary embodiments of the present disclosure, and is not intended to limit the protection scope of the present disclosure.

Those skilled in the art should appreciate that the term ‘user terminal’ covers any suitable type of wireless user equipment, such as a mobile phone, a portable data processing device, a portable web browser or an in-vehicle mobile station.

In general, various embodiments of the present disclosure may be implemented in hardware or dedicated circuit, software, logic, or any combination thereof. For example, some aspects may be implemented in hardware, while other aspects may be implemented in firmware or software that may be executed by a controller, microprocessor, or other computing device, although the present disclosure is not limited thereto.

Embodiments of the present disclosure may be implemented by a data processor of a mobile device executing computer program instructions, such as in a processor entity, either by hardware, or by a combination of software and hardware. Computer program instructions may be assembly instructions, instruction set architecture (ISA) instructions, machine instructions, machine-related instructions, microcode, firmware instructions, status setting data, or source or target code written in any combination of one or more programming languages.

A block diagram of any logic flow in the accompanying drawings of the present disclosure may represent program steps, or may represent interconnected logic circuits, modules, and functions, or may represent a combination of program steps with logic circuits, modules, and functions. A computer program may be stored in memory. The memory may have any type suitable for a local technical environment and may be implemented using any suitable data storage technology, such as, but not limited to, read only memory (ROM), random access memory (RAM), optical memory devices and systems (digital versatile discs (DVD) or compact discs (CD). The computer readable medium may include a non-transitory storage medium. The data processor may be any type suitable for a local technical environment, such as, but not limited to, a general-purpose computer, a special purpose computer, a microprocessor, a digital signal processor (DSP), an application specific integrated circuit (ASIC), a field-programmable gate array (FGPA), and a processor based on a multi-core processor architecture.

1. A method for determining a route for an optical channel (OCH) service, comprising:
determining a spectral width required for the OCH service in an optical network; and
successively determining at least one path in the route for the OCH service from a start network element of the OCH service to an end network element of the OCH service, wherein a maximum available spectral width of each of the at least one path in the route is greater than or equal to the spectral width required for the OCH service.

2. The method according to claim 1, wherein the at least one path in the route includes at least one path between respective network elements, the at least one path between the respective network elements represents at least one optical multiplex section (OMS) service at a service layer between each network element, and wherein a maximum available spectral width of each of the at least one OMS service at the service layer between the respective network elements includes a maximum available spectral width of each of at least one center frequency at the service layer between the respective network elements.

3. The method according to claim 1, wherein the at least one path in the route includes at least one path inside at least one network element, and the at least one path inside the at least one network element represents a OCH switching capability of the at least one network element.

4. The method according to claim 1, wherein when each network element is in an electrical relay mode, the maximum available spectral width of each of the at least one path between the respective network elements being in the electrical relay mode is greater than or equal to the spectral width required for the OCH service converted through the electrical relay mode of each network element.

5. The method according to claim 1, wherein successively determining the at least one path in the route for the OCH service from the start network element of the OCH service to the end network element of the OCH service comprises:
calculating differences between the spectral width required for the OCH service and maximum available spectral widths of paths between the respective network elements which are greater than or equal to the spectral width required for the OCH service, to successively determine the at least one path in the route for the OCH service from the start network element of the OCH service to the end network element of the OCH service, wherein a sum of differences between the maximum available spectral width of each of the at least one path in the route and the spectral width required for the OCH service is minimum.

6. (canceled)

7. (canceled)

8. (canceled)

9. An optical network controller, comprising:
at least one processor; and
memory communicatively coupled to the at least one processor;
wherein the at least one processor is configured to execute program instructions stored in the memory to perform a method for determining a route for an OCH service; wherein the method comprises:
determining a spectral width required for an OCH service in an optical network; and
successively determining at least one path in a route for the OCH service from a start network element of the OCH service to an end network element of the OCH service, wherein a maximum available spectral width of each of the at least one path in the route is greater than or equal to the spectral width required for the OCH service.

10. A non-transitory storage medium storing computer programs that, when executed by at least one processor, cause the at least one processor to perform a method for determining a route for an OCH service; wherein the method comprises:
determining a spectral width required for an OCH service in an optical network; and
successively determining at least one path in a route for the OCH service from a start network element of the OCH service to an end network element of the OCH service, wherein a maximum available spectral width of each of the at least one path in the route is greater than or equal to the spectral width required for the OCH service.

11. The optical network controller according to claim 9, wherein the at least one path in the route includes at least one path between respective network elements, the at least one path between the respective network elements represents at least one optical multiplex section (OMS) service at a service layer between each network element, and wherein a maximum available spectral width of each of the at least one OMS service at the service layer between the respective network elements includes a maximum available spectral width of each of at least one center frequency at the service layer between the respective network elements.

12. The optical network controller according to claim 9, wherein the at least one path in the route includes at least one path inside at least one network element, and the at least one path inside at least one network element represents a OCH switching capability of at least one network element.

13. The optical network controller according to claim 9, wherein when each network element is in an electrical relay mode, the maximum available spectral width of each of the at least one path between the respective network elements being in the electrical relay mode is greater than or equal to the spectral width required for the OCH service converted through the electrical relay mode of each network element.

14. The optical network controller according to claim 9, wherein successively determining the at least one path in the route for the OCH service from the start network element of the OCH service to the end network element of the OCH service comprises:
calculating differences between the spectral width required for the OCH service and maximum available spectral widths of paths between the respective network elements which are greater than or equal to the spectral width required for the OCH service, to successively determine the at least one path in the route for the OCH service from the start network element of the OCH service to the end network element of the OCH service, wherein a sum of differences between the maximum available spectral width of each of the at least one path in the route and the spectral width required for the OCH service is minimum.

15. The non-transitory storage medium according to claim 10, wherein the at least one path in the route includes at least one path between respective network elements, the at least one path between the respective network elements represents at least one optical multiplex section (OMS) service at a service layer between each network element, and wherein a maximum available spectral width of each of the at least one OMS service at the service layer between the respective network elements includes a maximum available spectral width of each of at least one center frequency at the service layer between the respective network elements.

16. The non-transitory storage medium according to claim 10, wherein the at least one path in the route includes at least one path inside at least one network element, and the at least one path inside at least one network element represents a OCH switching capability of at least one network element.

17. The non-transitory storage medium according to claim 10, wherein when each network element is in an electrical relay mode, the maximum available spectral width of each of the at least one path between the respective network elements being in the electrical relay mode is greater than or equal to the spectral width required for the OCH service converted through the electrical relay mode of each network element.

18. The non-transitory storage medium according to claim 10, wherein successively determining the at least one path in the route for the OCH service from the start network element of the OCH service to the end network element of the OCH service comprises:
calculating differences between the spectral width required for the OCH service and maximum available spectral widths of paths between the respective network elements which are greater than or equal to the spectral width required for the OCH service, to successively determine the at least one path in the route for the OCH service from the start network element of the OCH service to the end network element of the OCH service, wherein a sum of differences between the maximum available spectral width of each of the at least one path in the route and the spectral width required for the OCH service is minimum.
